(19) United States
(12) Patent Application Publication
(10) Pub. No.: US 2014/0199107 A1
(43) Pub. Date: Jul. 17, 2014

(54) Ergonomic Keyboard

(71) Applicant: Maria J. Jorge, West Hartford, CT (US)

(72) Inventor: Maria J. Jorge, West Hartford, CT (US)

(21) Appl. No.: 13/740,350

(22) Filed: Jan. 14, 2013

(51) Int. Cl. G06F 3/02

(52) U.S. Cl. CPC G06F 3/0202
USPC 400/489

(57) ABSTRACT

An ergonomic keyboard comprises a right hand module and a left hand module. Each of the modules comprises multiple parallel adjacent banks of four aligned keys. Each key is sequentially positioned at a mean distance from a reference position and has a corresponding effective actuation surface defined by an effective height and surface profile orientation. Each of the reference positions is determined by the relative length of the digits of a representative human hand.

### BACKGROUND

This disclosure relates generally to keyboards. More particularly, this disclosure relates to keyboards which have been modified for ergonomic considerations.

Numerous occupations now involve intensive usage of keyboards. Administrative assistants, typists, secretaries and numerous other professionals are involved in highly repetitive manual activities over extended periods of time. Such activities frequently result in abnormal tensions in the fingers and hands, as well as abnormal reactive tensions on the shoulders, necks and arms. Many professionals that engage in intensive keyboard entry have been diagnosed with carpal tunnel syndrome and other debilitating conditions.

Numerous proposals have been advanced to address the physical ailments which result from intense usage of keyboards, such as U.S. Pat. No. 6,802,662 for a non-linear ergonomic keyboard, U.S. Pat. No. 5,318,367 for a pivotal keyboard arrangement, U.S. Pat. No. 5,660,488 for an ergonomically condensed QWERTY keyboard, and U.S. Pat. No. 5,129,747 for a keyboard.

An important consideration in modifying a keyboard is to maintain as much as practical the relative positions of the keys to thereby lessen any learning curve for using the modified keyboard. It is also important to provide a keyboard which is capable of enhancing typing speed.

### SUMMARY

Briefly stated an ergonomic keyboard comprises a right hand module and a left hand module comprises four parallel adjacent banks b1, b2, b3e and b4 of four aligned keys, k1, k2, k3 and k4. Each key, k1-k4 of each bank b1-4 is sequentially positioned at a distance d1, d2, d3 and d4 from a respective reference position r1, r2, r3 and r4. Each key, k1, k2, k3 and k4 has a unique corresponding effective actuation surface s1, s2, s3 and s4 defined by an effective height and surface configuration. Each reference position, r1, r2, r3 and r4 is determined by relative lengths of digits of a representative human hand. The distances d1, d2, d3 and d4 for each bank, b1, b2, b3 and b4 are correspondingly equal. The surfaces s1, s2, s3 and s4 for the respective keys of each b1, b2, b3 and b4 are correspondingly substantially the same.

The ergonomic keyboard also comprises a left hand module comprising four parallel adjacent banks B1, B2, B3 and B4 of four aligned keys K1, K2, K3 AND K4. Each key K1, K2, K3 and K4 of each bank is positioned at a distance D1, D2, D3 and D4 from a reference position R1, R2, R3 and R4. Each key K1, K2, K3 AND K4 has a unique corresponding effective actuation surface S1, S2, S3 and S4 defined by an effective height and a surface configuration. Each reference position R1, R2, R3 and R4 is determined by relative lengths of digits of a representative human hand. Since the key distances D1, D2, D3 and D4 for each bank B1, B2, B3 and B4 are correspondingly equal, the surfaces S1, S2, S3 and S4 for the respective keys of each bank B1, B2, B3 and B4 are correspondingly substantially the same.

The keys k1, k2, k3 and k4 each have a mean height for the corresponding surfaces s1, s2, s3 and s4 which are correspondingly substantially the same for each bank b1, b2, b3 and b4. The respective heights are preferably such that s2 is less than s1 and s3 and s4 has a greater height than s1, s2 and s3.

The surface s1 has a medial profile which oriented at an angle to the vertical of a first direction. The surface for s2 has a medial profile which is oriented at a general angle with respect to the vertical at a second direction. The distance between d1 and d2 equals the distance between d2 and d3 and also equals the distance between d4 and d3.

In one embodiment the right hand module and the left hand module are integrated into a common key board. In another embodiment the right hand module and the left hand module are physically separated from each other and are displaceable relative to each other.

The ergonomic keyboard also preferably comprises a fifth bank of four aligned keys for each of the modules wherein each key is sequentially positioned at a distance d1, d2, d3, and d4 or distance D1, D2, D3 and D4 from the r4 or R4 reference position. the right hand module also has a bank b0 of four keys k1-k4 adjacent key bank b1

Keys k1, k2, k3 and k4 each have a height for the respective surfaces s1, s2, s3 and s4 which are correspondingly equal to the height for surfaces S1, S2, S3 and S4. The surfaces s1 and S1 each have a medial profile which oriented at an angle to the vertical in a first direction. The surface for s2 and S2 each have a medial profile which is oriented at a general angle with respect to the vertical at a second direction, and the surfaces for s3 and S3 each have a medial profile which is oriented at a third angle orientation to the vertical.

In a preferred embodiment, the distance d1 equals D1, d2 equals D2, d3 equals D3 and d4 equals D4, and the distance between D1 and D2, the distance between D2 and D3 and the distance between D3 and D4 are substantially equal.

### BRIEF DESCRIPTION OF THE DRAWINGS

FIG. 1 is a top plan view, of an ergonomic keyboard;

FIG. 2 is a side elevational profile view of a representative bank of keys for the ergonomic keyboard of FIG. 1;

FIG. 3 is a top plan view for the representative bank of keys of FIG. 2;

FIG. 4 is a diagrammatic top plan view, of a right hand component for a divided ergonomic keyboard;

FIG. 5 is a diagrammatic top plan view, partly in schematic, of a left hand component of a divided ergonomic keyboard;

FIG. 6 is a diagrammatic schematic view of a right hand module employed in the ergonomic keyboard of FIGS. 1; and

FIG. 7 is a diagrammatic schematic view of a left hand module employed in the ergonomic keyboard of FIG. 1.

### DETAILED DESCRIPTION

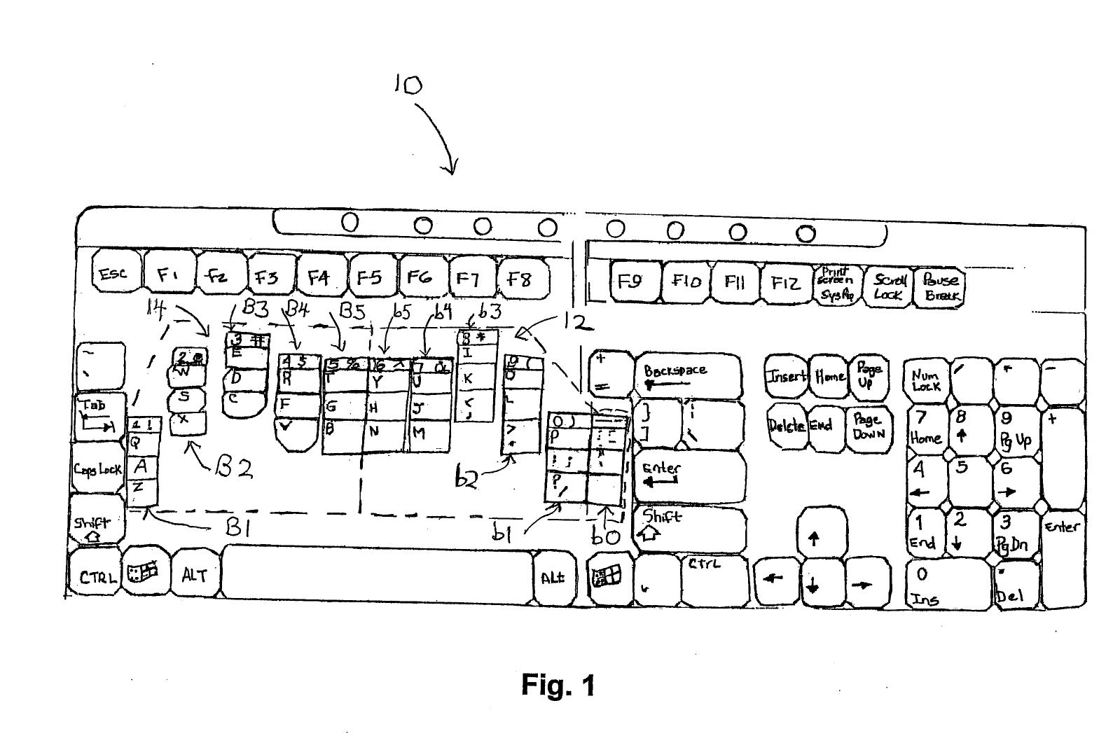

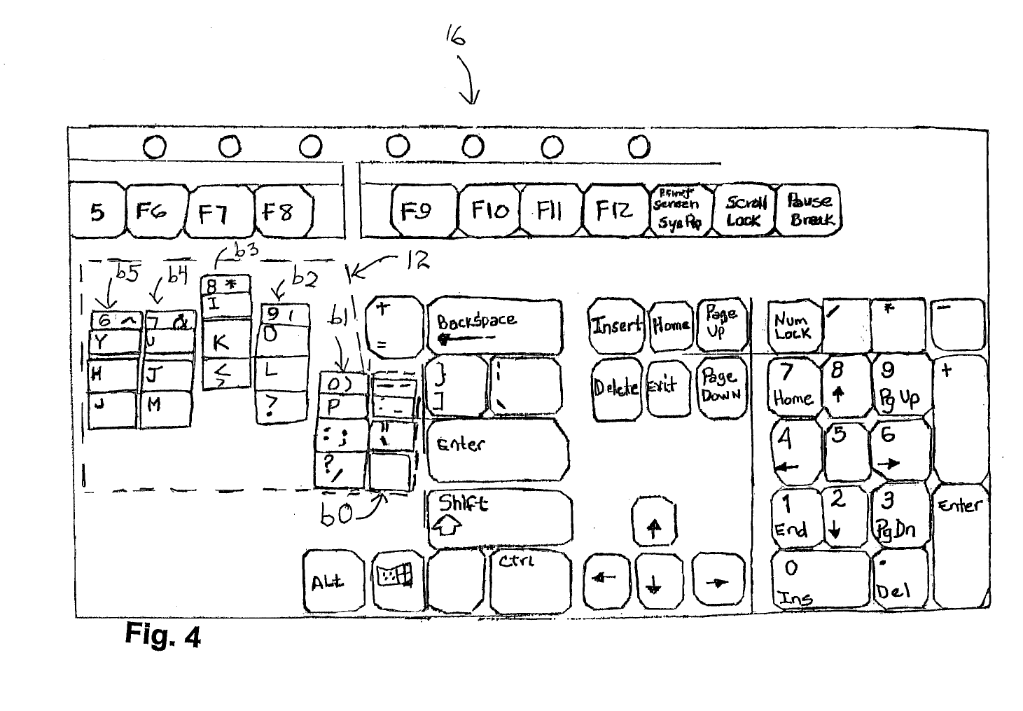

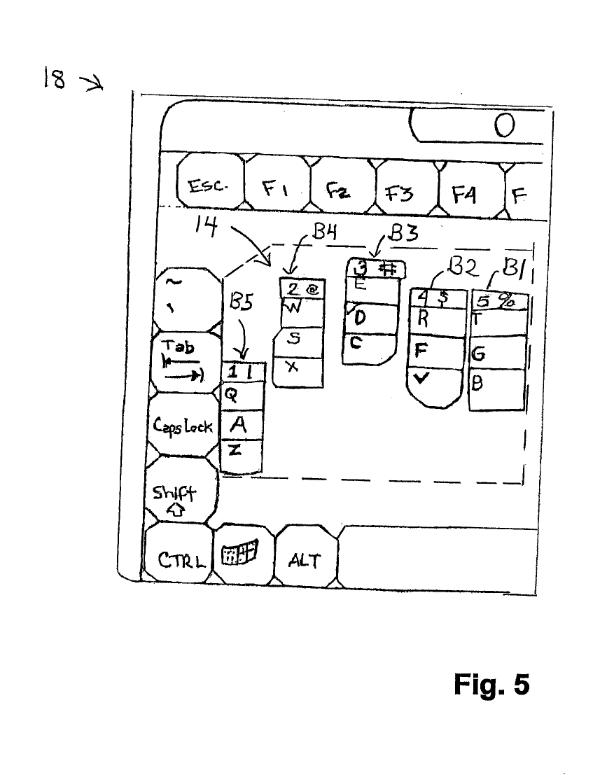

With reference to the drawings wherein like numerals represent like parts throughout the several figures, an ergonomic keyboard is designated generally by the numeral 10 in FIG. 1. The ergonomic keyboard generally has the same keys as the standard keyboard with the keys being located in their generally customary position, except that, for some intensively used portions, the position of the keys as well as the height and general surface of the keypads of each of the keys has been modified in accordance with the representative relative positions of the human hand. The modified portion of the keyboard may be visualized as a right hand keyboard module 12 and a left hand module 14. The modules 12 and 14 are illustrated by broken lines. As respectively represented in FIGS. 4 and 5, in some embodiments, the keyboard 10 may actually physically be divided into separate right hand assemblage 16 incorporating the right hand module 12 and a left hand assemblage 18 incorporating a left hand module 14. Many portions of the standard keyboard essentially remain unchanged and generally are not discussed.

Principal ergonomically modified portions of the keyboard 10 may be envisioned as being sub-divided into eleven banks or columns of keys. Six banks of keys designated b0, b1, b2, b3, b4 and b5 correspond to keys to be activated by the right hand and five banks of keys B1, B2, B3, B4 and B5 are keys designated to be activated by the left hand. Each bank of keys contains four vertically aligned keys.

The key banks used by the digits (little finger, ring finger, middle finger and forefinger) are respectively b1, b2, b3 and b4 for the right hand and B1, B2, B3 and B4 for the left hand. The keyboard can best be understood in terms of four principal key banks for the right hand and four key banks for the left hand. The relative positions of the digit banks are determined from a reference r1, r2, r3 and r4 (right hand) and R1, R2, R3 and R4 (for the left hand) which are arbitrary positions related in accordance with the relative length from the tip of the four digits for a representative hand in the extended position. The foregoing keys form two matrices of keys, which generally constitute the most frequently used keys.

Keyboards b0 and b1 are configured to be struck by the same right little finger and have the same relative positions. Key banks b4 and b5 are configured to be struck by the same right forefinger and have the same relative positions. Key banks b4 and b5 are configured to be struck by the same left hand forefinger and also have the same relative positions. Consequently, key banks b0, b5 and B5 will not be extensively discussed.

Each of the keys generally has the same key pad dimensional footprint which generally corresponds to that of a conventional standard keyboard. However, the mean height of each key pad in a given bank is related to the relative position from the reference of a given key in the bank. In addition, the top surface of the each key pad is contoured and oriented in accordance with the relative position of the key in a given bank.

The keys for each of the right hand and the left hand modules may be organized in a matrix designed by the respective letters bk, and BK, and two numeric subscripts, one for the bank and the second for the position of the key within the bank. Accordingly, the keys k1, k2, k3 and k4 for each of the banks b1, b2, b3 and b4 for usage by the digits for the right hand keyboard module are represented by Table I below.

TABLE I

| | BANK | | | | | |
|---|---|---|---|---|---|---|
| KEY | b0 | b1 | b2 | b3 | b4 | b5 |
| k1 | | ? / | > . | < , | M | N |
| k2 | “ ’ | : ; | L | K | J | H |
| k3 | { [ | P | O | I | U | Y |
| k4 | _ - | 0 ) | 9 ( | 8 * | 7 & | 6 \hat{ } |

The keys for the left hand module are represented by Table II below.

TABLE II

| | BANK | | | | |
|---|---|---|---|---|---|
| KEY | B1 | B2 | B3 | B4 | B5 |
| K1 | Z | X | C | V | B |
| K2 | A | S | D | F | G |
| K3 | Q | W | E | R | T |
| K4 | 1 ! | 2 @ | 3 # | 4 $ | 5 % |

It will be appreciated that, for example, with reference to the keyboard of FIG. 1, when the left hand is in a given extended position, the anterior tips of the digits will engage A, S, D and F. The right hand digits for the given extension will engage J, K, L and “;”, “:”, “′”, and “″”. If, for example, the left hand is moved downwardly, then the tips would engage Z, X, C and V for the left hand and M, “<” and “,”, “>”, “.”, “?” and “/” for the right hand.

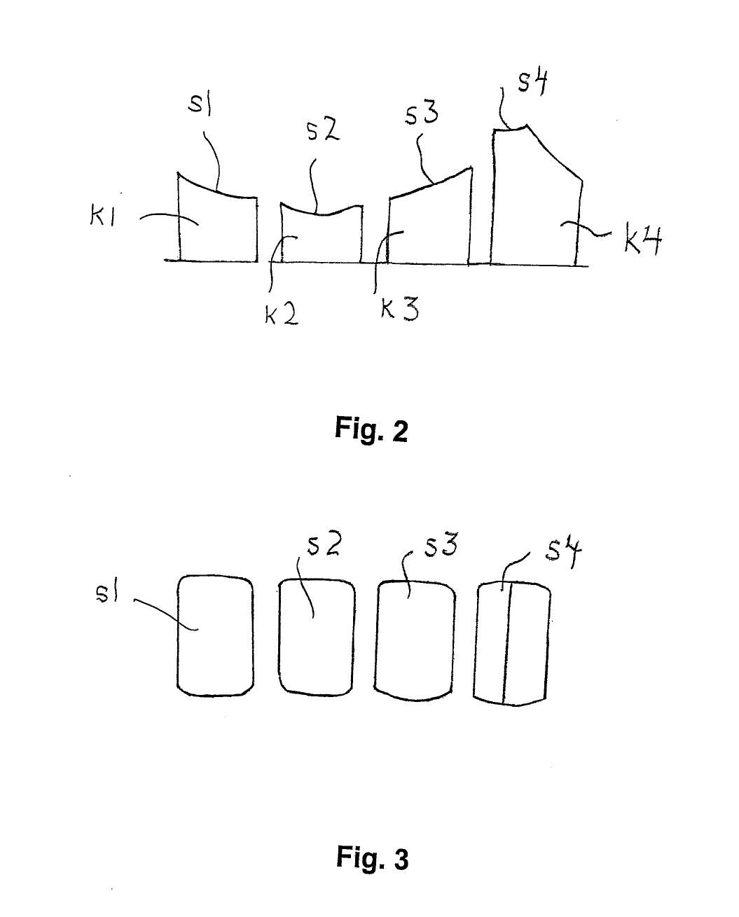

The mean height of each key k1 of each of the banks b0, b1, b2, b3, b4 and b5 is the same height. The same equal mean height relationships hold for k2, k3, and k4 for each of the banks b0, b1, b2, b3 and b4. As best represented in FIG. 2 for any given bank, the mean heights of the keys k1 will be higher than the given mean heights of keys k2, and the mean heights for keys k3 will be higher than the mean heights for keys k2, and approximately the same mean heights as k1. The mean heights for keys k4 will be significantly higher than for keys k3.

The effective contact surfaces s1, s2, s3 and s4 of the key pads for the respective keys k1, k2, k3, and k4 are oriented so that in a side medial profile, key pad surface s1 is inclined slightly downwardly toward key pad surface s2 which is generally semi-horizontally inclined. The effective contact surface s4 for key pad surface s3 is inclined upwardly and the effective upper surface for key pad surface s4 is generally upwardly, but at a higher level than that for surface s3. Preferably, each of the four key pad contact surfaces for the keys in a bank will be slightly concave. In some embodiments the contact area of surface s4 is narrower and smaller in area than other contact surfaces. The effective contact surfaces s1-s4 of the respective keys k1-k4 have the same relationship for each of banks b0-b5.

The same corresponding relationships apply for the contact surfaces S1-S4 of the respective keys K1-K4 for each of the banks B1-B5 for the left hand module.

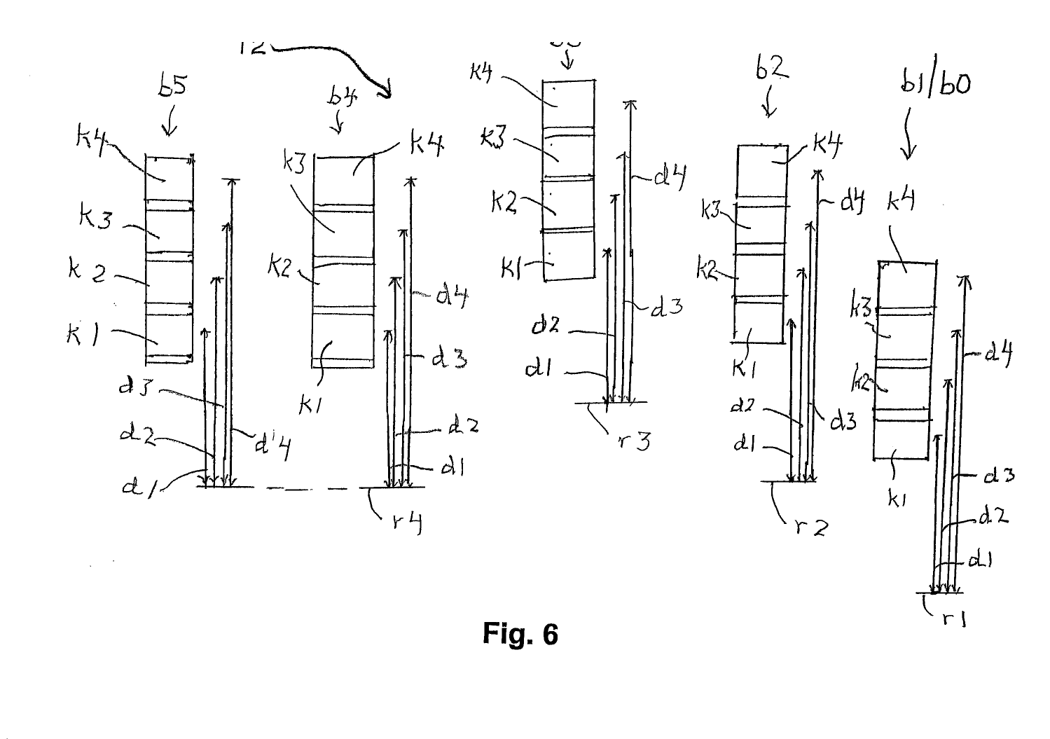

With reference to Table III, FIG. 4 and FIG. 6, the distance for a given key kn of the right hand bank from a reference position m for a given bank bm is indicated by a distance do from m, where n is 1, 2, 3 and 4 and m is 1, 2, 3 and 4. Each of the banks for key k1, k2, k3, and k4 has a corresponding difference reference position r1, r2, r3 and r4 which are determined by differences between the mean extension lengths of the digits. The actual positions r1-r4 are arbitrary provided the digit length difference relationships are maintained.

If a representative right hand were superimposed on FIG. 4. Consequently, it would be appreciated that for a given key kn for each of the banks, the corresponding distance do will be equal. In addition, the pad surface features sn for each of the respective keys key n in a key bank will also be identical. These relationships are set forth in Table III.

TABLE III

| | PAD | REFERENCE | |
|---|---|---|---|
| KEY | SURFACE | POSITION | DISTANCE |
| b0k1 | s1 | r1 | d1 |
| b0k2 | s2 | r1 | d2 |
| b0k3 | s3 | r1 | d3 |
| b0k4 | s4 | r1 | d4 |
| b1k1 | s1 | r1 | d1 |
| b1k2 | s2 | r1 | d2 |
| b1k3 | s3 | r1 | d3 |
| b1k4 | s4 | r1 | d4 |
| b3k1 | s1 | r3 | d1 |
| b3k2 | s2 | r3 | d2 |
| b3k3 | s3 | r3 | d3 |
| b3k4 | s4 | r3 | d4 |
| b4k1 | s1 | r4 | d1 |
| b4k2 | s2 | r4 | d2 |
| b4k3 | s3 | r4 | d3 |
| b4k4 | s4 | r4 | d4 |
| b5k1 | s1 | r4 | d1 |
| b5k2 | s2 | r4 | d2 |
| b5k3 | s3 | r4 | d3 |
| b5k4 | s4 | r4 | d4 |

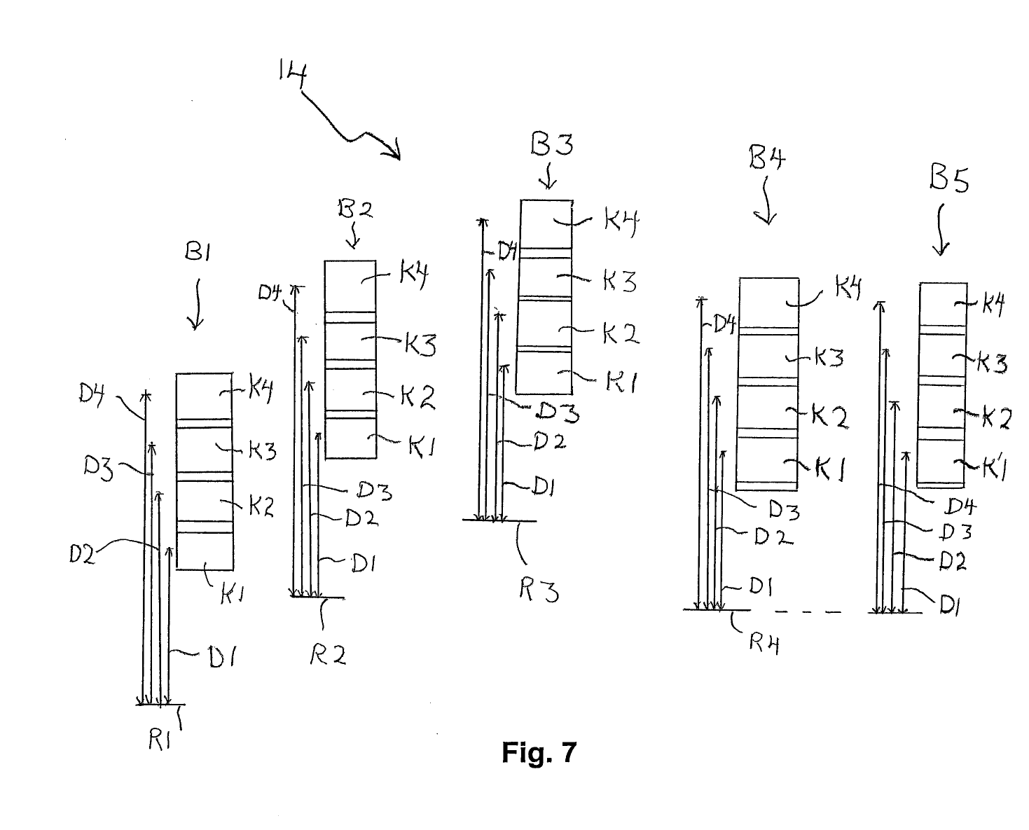

Likewise, with respect to Table IV, FIG. 5 and FIG. 7, the relationships for the left hand key module 14 will also be based on reference positions R1, R2, R3 and R4 which are based on the distances Dn from the tip of the left hand digits of a representative hand in the extended position. It will, of course, be appreciated that the specific reference positions ml are arbitrary, but are essentially differences for a representative hand. It can also be seen that the mean distances Dn of a given key Kn will be the same for each of the banks B1, B2, B3 and B4. Likewise, the surface characteristics Sn for a given key Kn will be identical for each of the banks. The mean key height relationships and key pad surface characteristics for the left hand module are the same as previously described for the right hand module. These relationships are set forth in Table IV.

TABLE IV

| | | REFERENCE | |
|---|---|---|---|
| KEY | SURFACE | POSITION | DISTANCE |
| B1K1 | S1 | R1 | D1 |
| B1K2 | S2 | R1 | D2 |
| B1K3 | S3 | R1 | D3 |
| B1K4 | S4 | R1 | D4 |
| B2K1 | S1 | R2 | D1 |
| B2K2 | S2 | R2 | D2 |
| B2K3 | S3 | R2 | D3 |
| B2K4 | S4 | R2 | D4 |
| B3K1 | S1 | R3 | D1 |
| B3K2 | S2 | R3 | D2 |
| B3K3 | S3 | R3 | D3 |
| B3K4 | S4 | R3 | D4 |
| B4K1 | S1 | R4 | D1 |
| B4K2 | S2 | R4 | D2 |
| B4K3 | S3 | R4 | D3 |
| B4K4 | S4 | R4 | D4 |
| B5K1 | S1 | R4 | D1 |
| B5K2 | S2 | R4 | D2 |
| B5K3 | S3 | R4 | D3 |
| B5K4 | S4 | R4 | D4 |

For the illustrated keyboard 10, the following relationships apply where n=1, 2, 3, 4:

sn=Sn Where n=1,2,3,4

dn=Dn

d(k−l)=w Where k=4,3,2

l=k−1
w=approximate constant
width of the keypad footprint

For some ergonomic keyboards, such as when the right and left modules are separate structures, the right/left relationships may not strictly apply.

For one representative embodiment:

d2−d1=2.50 cm=D2−D1

d3−d1=3.52 cm=D3−D1

d4−d1=2.75 cm=D4−D1

For a second representative embodiment:

d2−d1=3.0 cm=D2−D1

d3−d1=4.0 cm=D3−D1

d4−d1=2.75 cm=D4−D1

It should be noted that for different individuals d4−d1>d2−d1 or d4−d1<d2−d1 or d4−d1=d2−d1 depending on the relative lengths of the forefinger and the ring finger. The relationship of d4−d1>d3−d1 and d4−d1>d2−d1 holds for the great majority of individuals.

It will be appreciated that for each of the left and right hand modules, there will be an additional bank of keys b5 and B5 which correspond to the relationships for b4 and b5. Likewise, the relationships for b0 corresponds to the relationship for b1.

It will be appreciated that the ergonomically configured keyboard allows the hands and fingers to be fully extended in their natural form to allow the arms to be in a more natural angle and placed in a more comfortable position. The keys are placed in a given bank at an effective keypad height and orientated so that a forward, backward, central and light movement is required to operate the given keys in a bank. It allows the fingers to essentially be fully extended instead of bent, thus easing the tension in the fingers and hands. The hands can easily be separated at a more natural position which also eases tension in the shoulders, neck and arms.

1. An ergonomic keyboard comprising:
a right hand module comprising four parallel, adjacent banks b1, b2, b3 and b4 of four aligned keys k1, k2, k3 and k4, each key k1, k2, k3 and k4 of each bank sequentially positioned at a distance d1, d2, d3 and d4 from a reference position r1, r2, r3 and r4 and having a unique corresponding effective actuation surface s1, s2, s3 and s4 defined by an effective height and a surface configuration, each reference position r1, r2, r3 and r4 being determined by relative lengths of digits of a representative human hand wherein the distances d1, d2, d3 and d4 for each bank b1, b2, b3 and b4 are correspondingly equal and the surfaces s1, s2, s3 and s4 for each bank b1, b2, b3 and b4 are correspondingly substantially the same; and
a left hand module comprising four parallel, adjacent banks B1, B2, B3 and B4 of four aligned keys K1, K2, K3 and K4, each key K1, K2, K3 and K4 of each bank sequentially positioned at a distance D1, D2, D3 and D4 from a reference position R1, R2, R3 and R4 and having a unique corresponding effective actuation surface S1, S2, S3 and S4 defined by an effective height and a surface configuration, each reference position R1, R2, R3 and R4 being determined by relative lengths of digits of a representative human hand wherein the distances D1, D2, D3 and D4 for each bank B1, B2, B3 and B4 are correspondingly equal and the surfaces S1, S2, S3 and S4 for each bank B1, B2, B3 and B4 are correspondingly substantially the same.

2. The ergonomic keyboard of claim 1 wherein keys k1, k2, k3 and k4, each have a mean height for the corresponding surfaces s1, s2, s3 and s4 which are correspondingly substantially the same for each bank.

3. The ergonomic keyboard of claim 2 wherein the respective mean heights are such that s2 is less than s1 and s3, and s4 has a greater height than s1, s2 and s3.

4. The ergonomic keyboard of claim 3 wherein the surface s1 has a medial profile which is oriented at an angle to the vertical at a first direction, the surface for s2 has a medial profile which is oriented at a general angle with respect to the vertical at a second direction, and the surface for s3 has a medial profile which is oriented at a third angle orientation to the vertical.

5. The ergonomic keyboard of claim 1 wherein the distance between d1 and d2, the distance between d2 and d3, and the distance between d3 and d4 are substantially equal.

6. The ergonomic keyboard of claim 1 wherein said right hand module and said left hand module are integrated into a common keyboard.

7. The ergonomic keyboard of claim 1 wherein said right hand module and said left hand module are physically separated from each other and are relatively displaceable.

8. The ergonomic keyboard of claim 1 further comprising a fifth bank of four aligned keys wherein each key is sequentially positioned at the distance d1, d2, d3 and d4 from the reference position r4.

9. An ergonomic keyboard comprising:
a right hand module comprising five parallel, adjacent banks b1, b2, b3, b4 and b5 of four aligned keys k1, k2, k3 and k4, each key k1, k2, k3 and k4 of each bank sequentially positioned at a distance d1, d2, d3 and d4 from a reference position r1, r2, r3 and r4 and having a corresponding effective pad surface s1, s2, s3 and s4 defined by a mean height, each reference position r1, r2, r3 and r4 being determined by relative lengths of digits of a representative human hand wherein the distances d1, d2, d3 and d4 for each bank b1, b2, b3, b4 and b5 are correspondingly equal and the respective mean heights of pad surfaces s1, s2, s3 and s4 for each bank b1, b2, b3, b4 and b5 are correspondingly substantially equal; and
a left hand module comprising four parallel, adjacent banks B1, B2, B3 and B4 of four aligned keys K1, K2, K3 and K4, each key K1, K2, K3 and K4 of each bank sequentially positioned at a distance D1, D2, D3 and D4 from a reference position R1, R2, R3 and R4 and having a corresponding effective pad surface S1, S2, S3 and S4 defined by a mean height, each reference position R1, R2, R3 and R4 being determined by relative lengths of digits of a representative human hand wherein the distances D1, D2, D3 and D4 for each bank B1, B2, B3 and B4 are correspondingly equal and the respective mean heights of pad surfaces S1, S2, S3 and S4 for each bank B1, B2, B3 and B4 are correspondingly substantially equal.

10. The ergonomic keyboard of claim 1 wherein keys k1, k2, k3 and k4, each have a height for the respective surfaces s1, s2, s3 and s4 which are correspondingly equal to the height for surfaces S1, S2, S3 and S4.

11. The ergonomic keyboard of claim 10 wherein the respective heights are such that s2 is less than s1 and s3, and s4 has a greater height than s1, s2 and s3.

12. The ergonomic keyboard of claim 11 wherein the surfaces s1 and S1 each have a medial profile which is oriented at an angle to the vertical at a first direction, the surface for s2 and S2 each have a medial profile which is oriented at a general angle with respect to the vertical at a second direction, and the surfaces for s3 and S3 each have a medial profile which is oriented at a third angle orientation to the vertical.

13. The ergonomic keyboard of claim 1 wherein d1 equals D1, d2 equals D2, d3 equals D3 and d4 equals D4 and, the distance between d1 and d2, the distance between d2 and d3, and the distance between d3 and d4 are substantially equal.

14. The ergonomic keyboard of claim 9 wherein said right hand module and said left hand module are integrated into a common keyboard.

15. The ergonomic keyboard of claim 9 wherein said right hand module and said left hand module are physically separated from each other.

16. The ergonomic keyboard of claim 9 further comprising a fifth bank of four aligned keys for each said module.

17. An ergonomic keyboard comprising:
a module comprising four parallel, adjacent banks b1, b2, b3 and b4 of four aligned keys k1, k2, k3 and k4, each key k1, k2, k3 and k4 of each bank sequentially positioned at a distance d1, d2, d3 and d4 from a reference position r1, r2, r3 and r4 and having a corresponding effective actuation surface s1, s2, s3 and s4 defined by an effective mean height and a surface configuration, each reference position r1, r2, r3 and r4 being determined by relative lengths of digits of a representative human hand wherein the distances d1, d2, d3 and d4 for each bank b1, b2, b3 and b4 are correspondingly equal and the effective mean height and surface configurations for respective surfaces s1, s2, s3 and s4 for each bank b1, b2, b3 and b4 are correspondingly substantially the same.

18. The ergonomic keyboard of claim 17 wherein the respective mean heights are such that s2 is less than s1 and s3, and s4 has a greater height than s1, s2 and s3.

19. The ergonomic keyboard of claim 18 wherein the surface s1 has a medial profile which is oriented at an angle to the vertical at a first direction, the surface for s2 has a medial profile which is oriented at a general angle with respect to the vertical at a second direction, and the surface for s3 has a medial profile which is oriented at a third angle orientation to the vertical.

20. The ergonomic keyboard of claim 17 wherein the distance between d1 and d2, the distance between d2 and d3, and the distance between d4 and d3 are substantially equal.
